(19) United States
(12) Patent Application Publication
(10) Pub. No.: US 2008/0128274 A1
(43) Pub. Date: Jun. 5, 2008

(54) Nanostructured sensor for high temperature applications

(75) Inventors: Raju A. Raghurama, Bangalore (IN); Ramsesh Anil Kumar, Bangalore (IN)

Correspondence Address: Bryan Anderson;Honeywell International Inc., 101 Columbia Rd., P.O. Box 2245, Morristown, NJ, 07962, US

(73) Assignee: Honeywell International Inc.

(21) Appl. No.: 11/633,776

(22) Filed: Dec. 4, 2006

(51) Int. Cl. B05D 5/12; C25B 9/00

(52) U.S. Cl. 204/290.1; 427/77

(57) ABSTRACT

A gas sensor utilizes nano-sized CeO₂ and doped CeO₂ particles for detecting NO, NO2 and also for studying the cross sensitivity of oxygen, un-burnt hydrocarbons, CO and CO₂. Nano-crystalline powders of CeO₂ and doped CeO₂ are employed to configure thin films on Platinum comb type electrodes preformed on alumina substrates. Various catalytic oxides are employed to convert the NO to NO₂ to get equal response to NOx gas. Gas sensing properties are measured using a dynamic chamber with a constant flow of air and NOX gas in required percentage in nitrogen gas.

### TECHNICAL FIELD

Embodiments are generally related to gas sensors. Embodiments are also related to the field of NOₓ sensors using nano-crystalline CeO₂. Embodiments are additionally related to CeO₂ (MOS) NOₓ sensors for high temperature applications.

### BACKGROUND OF THE INVENTION

The role of gases and the measurement of their concentration have always received wide spread applications in many fields of science and technology. This has resulted in an increasing demand for small scale solid-state sensors. NOₓ sensors for automotive exhaust gas environments are of great interest because of high expectations of nanostructured materials and ever increasing demands on emission control legislations. The sensitivity of a gas sensor is defined as the ratio of the resistance of the sensor element in air to the resistance of the sensor element in the test gas atmosphere (S=Rₐᵢᵣ/R_{gas}).

Many processes and devices have been used for sensing exhaust gases from automobile engines. NOₓ is one of the unwanted exhaust gases which pollute the environment. NOₓ is a term used to describe the total oxides of nitrogen, which are commonly estimated from the measured NO, based on the assumption that the total NOₓ is (combination of NO and NO2 with varying concentrations depend upon the engine conditions ranging from 40% to 5% for NO2 and 60% to 95% of NO). This assumption is generally acceptable when combustion exhaust gases are measured at the outlet of a combustion system and the oxygen concentration is low. If the measurement is made at the exhaust outlet or in the atmosphere, the NO₂ is likely much higher than total 5% of the total NOₓ.

Measurement of NO and NO₂ is recommended for accurate total NOₓ formation. NOₓ is important to measure because of reactions involving volatile organic compounds (VOCs) with nitrogen oxides (NOₓ) in the presence of sunlight form ozone in the atmosphere. Ground-level ozone and NOx for example, causes throat irritation, congestion, chest pains, nausea and labored breathing. Ozone can also aggravate respiratory conditions, such as chronic lung and heart diseases, allergies and asthma. Additionally, Ozone ages the lungs and may contribute to various types of lung diseases.

NOₓ is found in emissions from aircraft, automobiles and industrial factories and contributes to the production of acid rain, smog, and the depletion of the ozone layer. With the increase in the number of vehicles traveling the earth, the amount of NOₓ produced is also increasing, thereby causing a dangerous situation for the environment. Therefore, a reliable NOₓ sensor to monitor and control emissions while exposed to the harsh conditions is needed.

The development of gas sensor devices with optimized selectivity and sensitivity has been gaining prominence in recent years. The use of semiconductor fabrication line is the preferred manufacturing process because of the potential to reduce cost. However fundamental materials and processing issues which are critical for high performance gas sensors need to be addressed. Among the new technologies a nano-crystalline material offers immense promise for improved sensitivity.

Nano-crystalline materials are currently receiving a great deal of attention due to their unique physical properties, which derive from their nanometer scaled sizes. In nano-sized materials, for example, the surface to bulk ratio is much greater than coarse materials, so that the surface properties become paramount, which makes them particularly appealing in applications, such as gas sensors, where nano-sized properties can be exploited. Grain size reduction, for example, is one of the main factors for enhancing the gas sensing properties of semiconducting oxides. It is believed that improved sensing technologies can therefore be configured and developed by taking advantage of recent advances in nano-sized materials.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved NOₓ sensor to monitor and control emissions when exposed to harsh conditions.

It is another aspect of the present invention to provide for a gas sensor that utilizes nano-sized CeO₂ particles to detect NOₓ and study the cross sensitivity for oxygen, unburnt hydrocarbons, CO and CO₂.

The aforementioned aspects and other objectives and advantages can now be achieved as described herein. CeO₂ nano-crystalline powders are synthesized by employing sol-gel, co-precipitation as well as chemical vapor synthesis (CVS). Such powders are used for configuring thin films of CeO₂ on platinum inter digital comb type electrodes performed on alumina substrates to form a sensor thereof. On the other side of the sensor, a platinum heater is provided to maintain the sensor at high temperatures. The nano powders obtained by the above said methods are dispersed on these substrates by dip coating, or screen printing by adding the appropriate binders for making thin and thick films. Dispersing the nano-crystalline powders in organic solvents and by employing electrophoresis techniques, thin films also can be fabricated.

Sintering is carried out to enhance the adherence of these films to the substrate. Thick films are also prepared by using screen printing techniques of CeO₂ in association with an appropriate binder and sintered at higher temperatures. Such films can be impregnated with 2% platinum particles. The gas sensing properties of NOx can be carried out using a test apparatus, which can indicated that the sensitivity for 2500 pm of NO and NO₂ is approximately 250% and the response and recovery time are less than four seconds for the same concentration. The uniqueness of the disclosed technique and device stems from the control of the particle size and shape. Especially with chemical vapor synthesis, the particle size can be controlled up to 8 to 10 nm. Higher particle sizes are also easily achieved.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a gas sensor testing apparatus, which can be implemented in accordance with a preferred embodiment;

FIG. 2 illustrates side view of the CeO₂ NOx gas sensor which can be implemented in accordance with an alternative embodiment; and

FIG. 3 illustrates a perspective view of the back side of the sensor on which a platinum heater is provided on the substrate in accordance with the present embodiment.

FIG. 4 illustrates a flowchart of operations depicting logical operational steps for the preparation of nano-crystalline CeO₂ and doped CeO2 coating, in accordance with a preferred embodiment;

FIG. 5 illustrates a flowchart of operations depicting logical operational steps for the detection of NOₓ gases using CeO₂NOₓ gas sensor, in accordance with a preferred embodiment; and

FIG. 6 illustrates a side view of a sensor, which can be implemented in accordance with an alternative embodiment.

### DETAILED DESCRIPTION

The particular values and configurations discussed in these non-limiting examples can be varied and are cited merely to illustrate at least one embodiment and are not intended to limit the scope thereof.

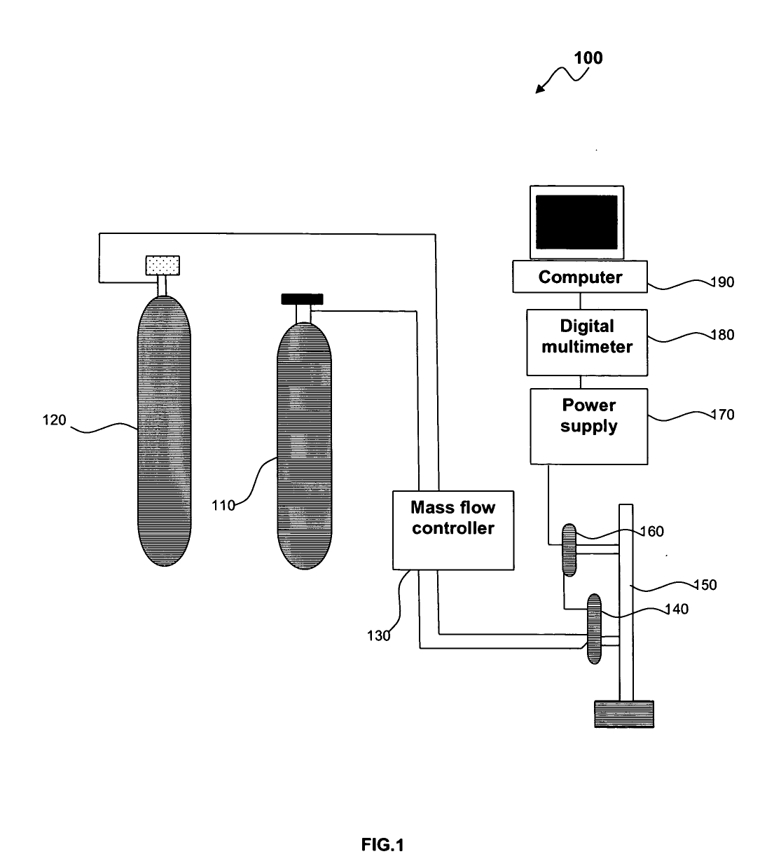

Referring to FIG. 1, a gas sensor testing apparatus 100 is illustrated, which can be implemented in accordance with a preferred embodiment. The gas sensor testing apparatus 100 generally includes two gas cylinder tanks 110 and 120. The gases NOₓ filled in cylinder 120 and dry air filled in 110 respectively flow from gas cylinder tanks 120 and 110, and are allowed to pass through a mass flow controller 130 to adjust the flow rate. Apparatus 100 further includes a two way gas valve 140. By adjusting the two way gas valve 140, NOx and dry air can be selectively passed on to a sensor 160 that detects the gas content.

Current voltage properties can be measured using a high voltage source 170 (e.g., a power supply). A stand 150 can also be provided upon which the two-way gas valve 140 and gas sensor 160 are connected. The conductance of the sensor 160 can be measured with a digital multimeter 180 that is connected electrically to the high voltage source 170 and also to a computer 190. The change in resistance can be simultaneously monitored by the digital multimeter 180. The apparatus 100 also includes the control computer 190, which is generally operable to control and manage the overall operation of the testing apparatus 100.

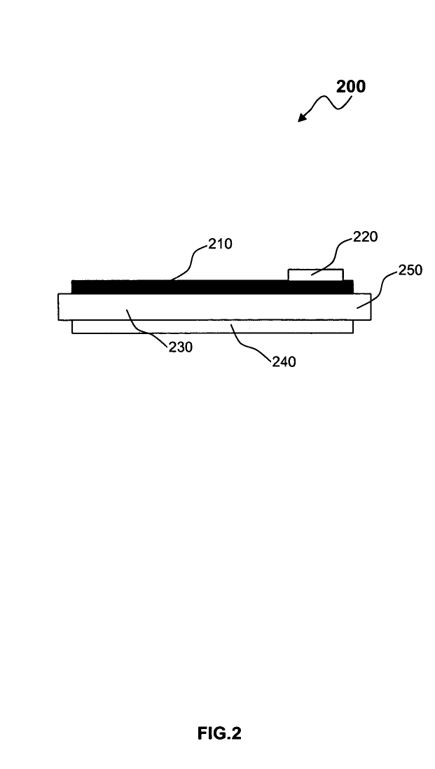

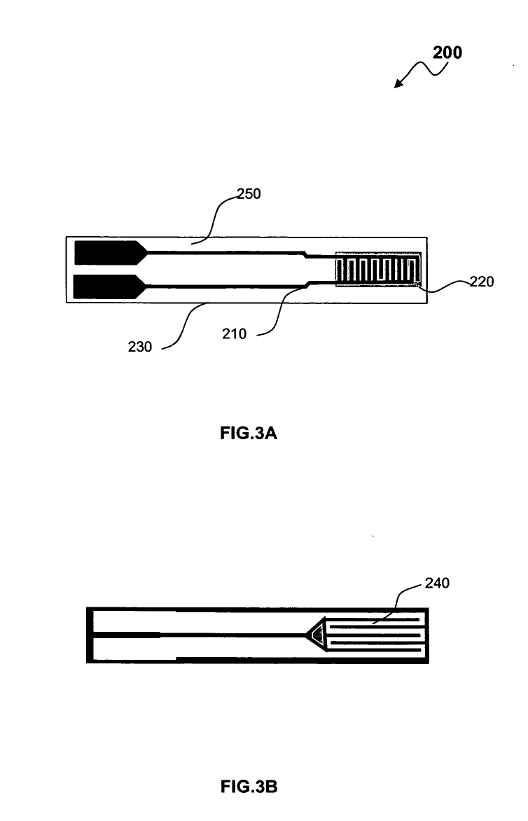

Referring to FIG. 2 a side view of a CeO₂ NOx gas sensor element 200 is illustrated, which can be implemented in accordance with a preferred embodiment. In FIGS. 2 and 3(a)-3(b), identical or similar parts or elements are generally indicated by identical reference numerals. Note that the CeO₂NOx gas sensor element 200 depicted in FIG. 2 can be adapted for use with the sensor 160 depicted in FIG. 1. The gas sensor 160 functions based on the fact that the changes of the oxide film resistance result from the reactions of the gases on the surface of the film 220 The gas sensor 160 includes the CeO₂NOx gas sensor element 200, which is composed of a platinum heater 240 formed in association with an alumina ceramic substrate 230. An interdigital comb of platinum electrodes 210 can be formed on one side of the alumina ceramic substrate 230. One or more thin films 220 of CeO₂ can be fabricated on the platinum electrodes 210 by electrophoresis. On the other side of the sensor element 200, the platinum heater 240 can be provided to maintain the sensor element 200 at high temperatures.

Referring to FIG. 3A, a front view of the CeO₂ NOx gas sensor element 200 is depicted, including a CeO₂ coating, in accordance with a preferred embodiment. The sensor platinum electrode 210 is generally provided in the context of an inter-digital comb structure, which maintains the resistance in an easily measurable range. The sensing mechanism of sensor element 200 is based on the electrofilic adsorption of NOₓ gas on the semi conducting oxide material (i.e., CeO₂) of the films 220. The change in conductivity of the sensor element 200 can be measured and calibrated with known concentrations.

Referring to FIG. 3B a back view of CeO₂ NOx gas sensor element 200 including one or more platinum heaters is illustrated in accordance with a preferred embodiment. On the back side of the substrate 230, the platinum heater 240 can be mounted in order to maintain the sensor element 200 at an appropriate operating temperature. A chemical reaction occurs when combustible gas reaches the sensing element 200. This action increases the temperature of the element 200, such that the heat is transmitted to the platinum heater 240.

A heating element is used to regulate the sensor temperature, since the finished sensors exhibit different gas response characteristics at different temperature ranges. This heating element can be a platinum or platinum alloy wire, a resistive metal oxide, or a thin layer of deposited platinum. The sensor element 200 can then be processed at a specific high temperature, which determines the specific characteristics of the finished sensor. In the presence of gas, the metal oxide causes the gas to dissociate into charged ions or complexes, which results in the transfer of electrons. The built-in platinum heater 240 thus heats the metal oxide material to an operational temperature range that is optimal for gas to be detected, and can optionally be regulated and controlled by a specific circuit. This specific circuit can be a chip (Application-Specific Integrated Circuit, ASIC) which can control sensor temperature through an independent measurement and heating mechanism of the micro heater present inside the chip.

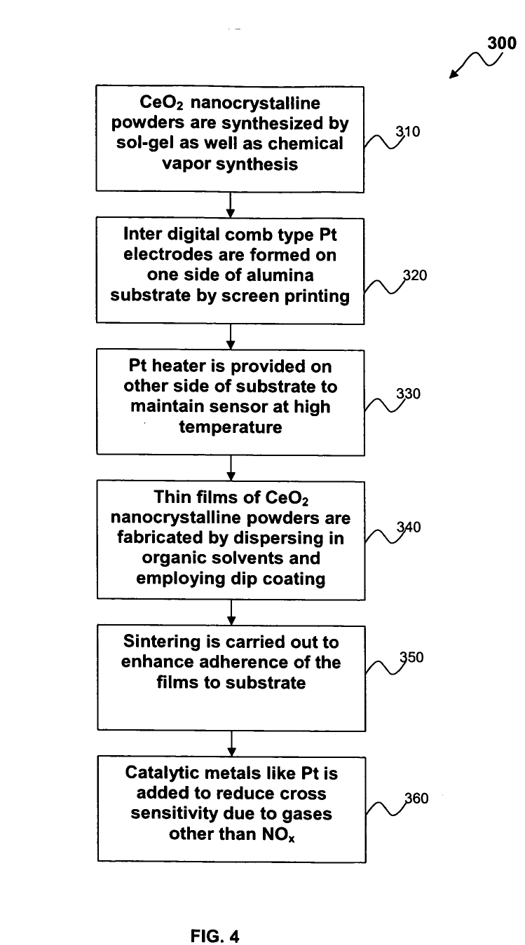

Referring to FIG. 4 a flowchart of operations is illustrated depicting logical operational steps for the preparation of a nano-crystalline CeO₂ coating, in accordance with a preferred embodiment. As indicated at block 310, CeO₂ nano crystalline powders can be synthesized by employing sol-gel, precipitation as well as chemical vapor synthesis. Inter digital comb type of Platinum electrodes are generally formed on one side of an alumina ceramic substrate, as indicated at block 320, by using a screen printing technique. Thereafter, as indicated at block 330, on the other side of the sensor, a Platinum heater can be provided to maintain the sensor at high temperatures. Nano-crystalline powders are generally dispersed in organic solvents and by employing electrophoresis or a dip coating technique as illustrated at block 340, the thin films can be fabricated.

Next, as indicated at block 350, a sintering operation can be carried out to enhance the adherence of these films to the substrate. The difficulty of sintering of CeO₂ (as the sintering temperature of CeO₂ is beyond 1600 C) is solved by adding inorganic binders mixing (5%) with CeO₂. Thick films can also be prepared using a screen printing technique of CeO₂ with an appropriate binder and sintered at high temperatures. The cross sensitivity of other gases (e.g., hydrocarbons, CO, CO₂ etc) can be checked thoroughly by adding a catalytic metal such as platinum 360 as depicted block 360. The cross sensitivity can thus be reduced to specified limits.

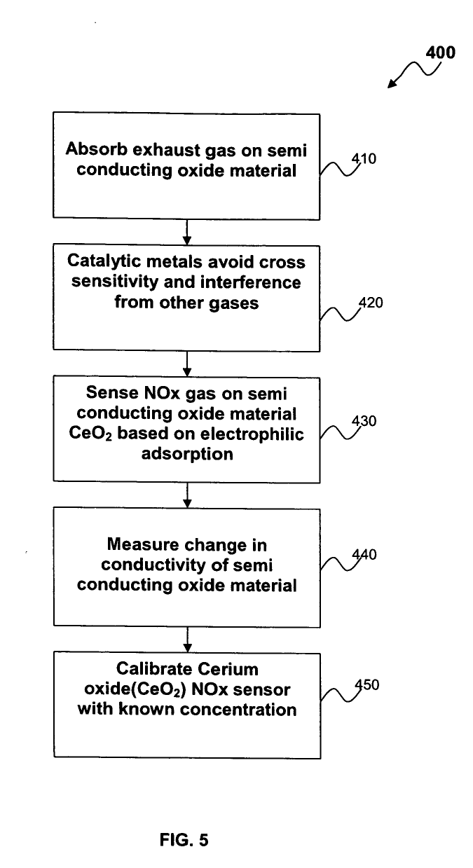

Referring to FIG. 5 a flowchart 400 of operations depicting logical operational steps for the detection of NOₓ gases using a CeO₂ NOₓ gas sensor is illustrated, in accordance with a preferred embodiment. As depicted at block 410, the exhaust gas can be absorbed on semi conducting oxide material. Thereafter, as indicated at block 420, catalytic metals can be applied to avoid cross-sensitivity and interference from other gases. Next, NOₓ gas can be sensed on a semi-conducting oxide material (CeO₂) based on electrophilic adsorption, as depicted at block 430. Thereafter, as depicted at block 440, changes in the conductivity of the semi-conducting oxide material can be measured. A Cerium Oxide (CeO₂) NOx sensor can then be calibrated with known concentration, as depicted at block 450.

In such an application, the sensor may produce a sensitivity of 200% with respect to a change of resistance for 2500 ppm of NO and NO₂. The particle size effect begins to occur below 50 nm with an order of magnitude increase in sensitivity for particles in 20 to 30 nm range. This particle size effect is due, in part, to an increase in the surface area since. In this range, a large fraction of the atoms (e.g., up to 50) are generally present at the surface or the interface region so that the structure and properties are different from that of the bulk material. However, the main effect is associated with the depth of the surface space charge region affected by gas adsorption in relation to the particle size. By employing a sol-gel process, for example, a 20 nm size of CeO₂ can be obtained. Such nano-powders are preferably mixed with adequate (5 to 10 wt %) amounts of ethylene glycol and the paste is then applied on to the platinum electrodes on an alumina substrate. The other method employed is by adding an appropriate amount (5 to 20% by wt) of binder ink making the printable ink for screen printing to be used for thick film sensor production.

The sensor described herein is very simple to fabricate and possesses a fast response and recovery for the NOₓ gas because of the presence of the nano-sized particles. Such benefits can be achieved due to the large surface area and reactive nature of the nano-crystalline powders. The cost of the sensor is relatively inexpensive, because large scale manufacturing processes such as screen printing can be employed. The electronics used to measure conductivity change are also much less complex and generally inexpensive. Cerium oxide in a thick film form, for example, can also be prepared using nanopowders and tested for NOₓ sensing. The methodology and device disclosed herein therefore uses nano-sized CeO₂ particles to detect NO and NO₂ and employs nano-crystalline powders of CeO₂ to configure thin films on Platinum comb type electrodes preformed on alumina substrates.

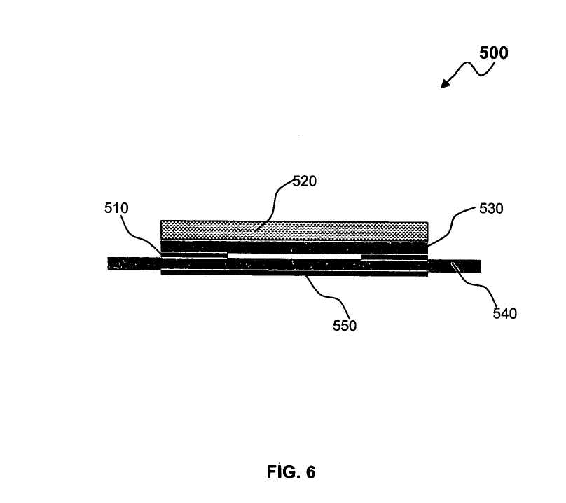

FIG. 6 illustrates a side view of a sensor 500, which can be implemented in accordance with an alternative embodiment. Sensor 500 generally includes a thick platinum film heater 550 formed in association with a substrate 540, which can be configured from alumina or ceramic. An inter-digital comb of electrodes 510 can be formed on one side of the alumina or ceramic substrate 540. Electrodes 510 can be formed from platinum. A thick film 530 of sensing element Ce₍₁₋ₓ₎ Tₓ O_{(2-y)} can be fabricated on the electrodes 510 by electrophoresis or screen printing, depending upon design considerations. A thick film 520 of catalyst material can be fabricated on the sensing element 530 (i.e., Ce₍₁₋ₓ₎ Tₓ O_{(2-y)}). On the other side of the sensor element 500, the platinum film heater 550 can be provided to maintain the sensor element 500 at high temperatures. The configuration of sensor 500 generally permits a catalyst material 520 or a combination of catalysts (e.g., WO₃, MoO₃, XWO₄, X₃WO₅, X₃W₂O₉ (x=Ca, Ba, Sr), YMoO₄, Y₂MoO₅, Y₃Mo₃O₉ (Y=Ca, Ba, Sr), to be used to convert the NO to NO₂ and sense the NOx gas of any combination of NO and NO₂ and to provide the same output. Sensor 500 thus constitutes an alternative version of a CeO₂ NOₓ sensor.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of providing a CeO₂ NOₓ gas sensor, comprising:
providing a substrate;
forming a pair of interdigital electrodes on a side of said substrate and a heater another side of said substrate; and
applying a coating of nano-crystalline powders of doped CeO₂ on said pair of interdigital electrodes formed on said substrate in order to form a CeO₂ NOₓ gas sensor.

2. The method of claim 1 further comprising configuring said pair of interdigital electrodes in a comb-type configuration upon said side of said substrate and said another side of said substrate.

3. The method of claim 1 wherein said substrate comprises alumina or such similar substrates of low thermal expansion coefficient.

4. The method of claim 1 wherein said substrate comprises a ceramic material or a semi-conducting material

5. The method of claim 1 further comprising configuring a heater upon said substrate wherein said heater and said pair of interdigital electrodes comprise platinum.

6. The method of claim 1 further comprising providing a catalyst material in order to convert NO to NO₂ and thereby detect NOx gas for any combination of NO and NO₂ by said CeO₂ NOx gas sensor and provide a same output thereof.

7. The method of claim 5 further comprising forming said heater utilizing a screen printing on said substrates following a sintering at a temperature of 1000° C.

8. The method of claim 1 wherein applying a coating of nano-crystalline powders of CeO₂ on said pair of interdigital electrodes formed on said substrate, further comprises:
synthesizing a nano-crystalline powder by employing a sol-gel and a chemical vapor synthesis;
dispersing said nano-crystalline powder in an organic solvent;
employing a dip coating or an electrophoresis operation to fabricate at least one thin film for deposition upon said substrate;
carrying out sintering operation to enhance an adherence of said at least one thin film to said substrate; and
adding a catalytic mesh of noble metal.

9. The method of claim 7 wherein said sintering operation is carried out by adding an inorganic binding mixture.

10. The method of claim 7 wherein said nano-crystalline powder is mixed with an equal amount of ethylene glycol and a paste applied thereafter to say on to said pair of interdigital electrodes.

11. A method of providing a CeO₂ NOₓ gas sensor, comprising:
providing a substrate;
forming a pair of interdigital electrodes on a side of said substrate and a heater another side of said substrate;
configuring said pair of interdigital electrodes in a comb-type configuration upon said side of said substrate and said another side of said substrate; and
applying a coating of nano-crystalline powders of doped CeO₂ on said pair of interdigital electrodes formed on said substrate in order to form a CeO₂ NOₓ gas sensor.

12. The method of claim 11 wherein said substrate comprises alumina or such similar substrates of low thermal expansion coefficient.

13. The method of claim 11 wherein said substrate comprises a ceramic material or a semi-conducting material

14. The method of claim 11 further comprising:
providing a catalyst material in order to convert NO to NO₂ and thereby detect NOx gas for any combination of NO and NO₂ by said CeO₂ NOₓ gas sensor and provide a same output thereof; and
forming said heater utilizing a screen printing on said substrates following a sintering at a temperature of 1000° C.

15. The method of claim 11 wherein applying a coating of nano-crystalline powders of CeO₂ on said pair of interdigital electrodes formed on said substrate, further comprises:
synthesizing a nano-crystalline powder by employing a sol-gel and a chemical vapor synthesis;
dispersing said nano-crystalline powder in an organic solvent;
employing a dip coating or an electrophoresis operation to fabricate at least one thin film for deposition upon said substrate;
carrying out sintering operation to enhance an adherence of said at least one thin film to said substrate; and
adding a catalytic mesh of noble metal.

16. A CeO₂ NOₓ gas sensor apparatus, comprising:
a substrate;
a pair of interdigital electrodes configured on a side of said substrate and a heater another side of said substrate; and
a coating of nano-crystalline powders of doped CeO₂ applied on said pair of interdigital electrodes formed on said substrate in order to form a CeO₂ NOₓ gas sensor.

17. The apparatus of claim 16 wherein said pair of interdigital electrodes are arranged in a comb-type configuration upon said side of said substrate and said another side of said substrate.

18. The apparatus of claim 16 wherein said substrate comprises alumina or such similar substrates of low thermal expansion coefficient.

19. The apparatus of claim 16 wherein said substrate comprises a ceramic material or a semi-conducting material

20. The apparatus of claim 16 further comprising a heater configured upon said substrate wherein said heater and said pair of interdigital electrodes comprise platinum.
